(19) United States
(12) Patent Application Publication
(10) Pub. No.: US 2001/0053077 A1
(43) Pub. Date: Dec. 20, 2001

(54) Electric torches

(75) Inventors: Nicholas Anwly-Davies, West Sussex (GB); Ross Bejamin Haffenden, Kent (GB)

Correspondence Address: Finnegan, Henderson, Farabow,, Garrett & Dunner, L.L.P., 1300 I Street, N.W., Washington, DC, 20005-3315, US

(73) Assignee: Seven of Nine Limited

(21) Appl. No.: 09/879,206

(22) Filed: Jun. 13, 2001

(30) Foreign Application Priority Data
Jun. 14, 2000 (GB) 0014560.7

(51) Int. Cl. F21L 4/02

(52) U.S. Cl. 362/184; 362/243; 362/255; 362/800

(57) ABSTRACT

Electric torches especially for use as bicycle lamps comprising a housing and two light sources (2, 4). A first of the light sources comprises a filament bulb (2) and a second of the light sources comprises an LED (4). Preferably the LED is a white light LED. The light sources may be arranged inline with one another or side by side one another.

This invention relates to electric torches. In particular this invention relates to electric torches which are suitable for use as bicycle lamps.

Typical existing bicycle lamps make use of filament bulbs which draw a large amount of power and thus, even when using alkaline batteries, the battery life is extremely limited, Moreover, as the batteries run down the lamp becomes dimmer and will become ineffective long before the batteries fully run out.

In urban situations, many roads have good street lighting and thus the need to have a bicycle light which lights up the rider's way forward becomes less of a priority. In such circumstances, what is of particular interest to the cyclist is that he or she will be seen by other road users.

Different sorts of light sources are available and may be suitable in different circumstances. At present, to meet the necessary requirements and safety standards for a bicycle light on an unlit road, it is necessary to use a filament bulb. However, on lit roads where being seen by other road users is the main objective, other types of light sources such as LEDs (Light Emitting Diodes) may be satisfactory. On the other hand, away from lit areas such LED lights do not meet the requirements of the user.

There will of course be other circumstances in which a filament bulb as a light source is appropriate at some times, whereas an LED as the light source is appropriate at other times.

In this application the term light source is used to mean a source of light which, in use, provides a useful illumination as a “be seen light” and/or “see by light”. That is to say the light source should be useful for either or both, being seen by others and illuminating the user's surroundings so that the user can see his or her way. This would not cover, for example, an LED which is being used purely to indicate that a device is in operation.

It is an object of this invention to provide a torch which alleviates at least some of the problems associated with the prior art.

According to the present invention there is provided an electric torch comprising a housing and two light sources, wherein a first of the light sources comprises a filament bulb and a second of the light sources comprises an LED. Preferably the LED is a white light LED.

Preferably means are provided for selecting operation of the desired light source(s).

It is envisaged that the user will use the LED as a light source when it is sufficient/desired to be seen, and the filament bulb when a “see by light” is required The savings in battery power can be significant as the LED will typically draw far less power than the filament bulb.

Preferably the torch is a bicycle light.

Preferably the housing is a common housing in which both of the light sources are housed.

The filament bulb and LED may be spaced from one another in a direction generally transverse to the direction of the output beam of one or both of the light sources. In some such cases the bulb and LED may be said to be side by side.

The filament bulb and LED may be spaced from one another in a direction generally parallel to the direction of the output beam of one or both of the light sources. In such cases the filament bulb and LED may have substantially no spacing in directions generally transverse to the direction of the output beam of one or both of the light sources. In such cases the bulb and LED may be said to be inline. This leads to a particularly compact structure and can minimise the number of components of a standard filament bulb torch that have to be modified to allow inclusion of the LED.

A reflector for directing the beam of the filament bulb may be disposed in the housing and the LED may be disposed within a projection area of the reflector. Here the term projection area is used to mean all points in space which would be in shadow if the reflector were lit directly from behind by a parallel beam. Preferably the LED is disposed centrally within the projection area, typically this will be substantially at the optical axis of the reflector.

Preferably an optical distribution device is provided for directing light output by the LED. Typically the optical distribution device is formed of a suitable optical material and comprises a portion arranged for receiving the light emitting portion of the LED and a portion for directing emitted light. The directing portion may be generally frusto-conical.

The axis of the optical distribution device may be substantially parallel to the axis of the reflector.

Preferably a lens is provided for directing the light of the filament bulb and/or LED. Typically such a lens also acts as a cover for the bulb and LED.

The beam characteristics, such as shape and intensity, of some torches, for example bicycle lights, have to meet with certain regulations. Any one of, or any combination of: the reflector, the optical distribution device and the lens may be arranged to achieve the desired beam characteristics for both beams but particularly that generated by the filament bulb.

To produce a wide horizontal beam for a bicycle torch, vertical (when in use) pillow lenses are often provided on the front cover lens. Where an inline arrangement of bulb and LED is used, it has been found desirable to leave vertical edge portions of the front cover lens free of pillow lenses. This aids in achieving the desired filament bulb beam characteristics. It is preferred to leave a quarter to a sixth of the total width of the lens free of pillow lenses at each end of the lens

In some embodiments, the optical distribution device comprises two spaced light directing projections, which project beyond the remainder of the light directing portion. The directing projections are preferably spaced in a direction substantially perpendicular to a direction in which the greatest filament bulb beam width is desired The projections may be of a partial frusto-conical shape.

Such an arrangement is particularly suitable where the torch is a bicycle light and a wide horizontal beam is required when using the filament bulb.

Embodiments of the present invention will now be described, by way of example only, with reference to the accompanying drawings in which:

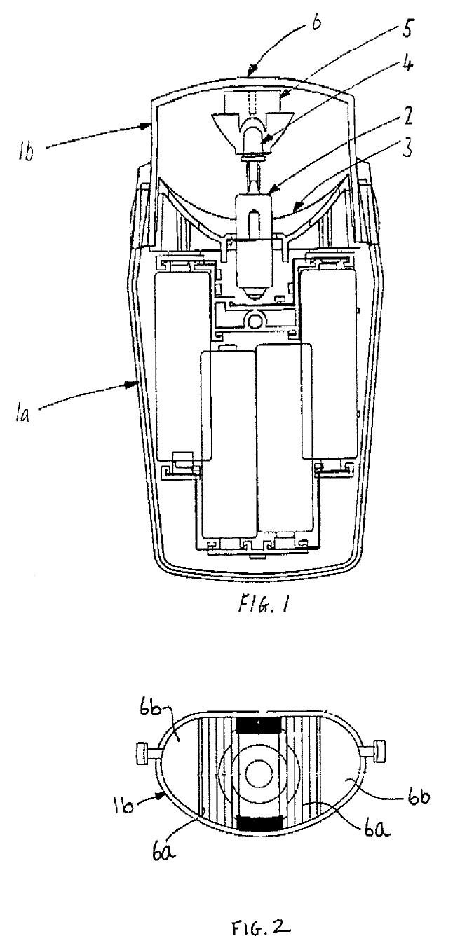

FIG. 1 is a schematic plan view of a bicycle light,

FIG. 2 is a front view of the bicycle light shown in FIG. 1;

FIG. 3 is a plan view of the front portion of the light shown in FIG. 1 showing more detail of the optical arrangement;

FIG. 4 is a side view of the front portion shown in FIG. 3;

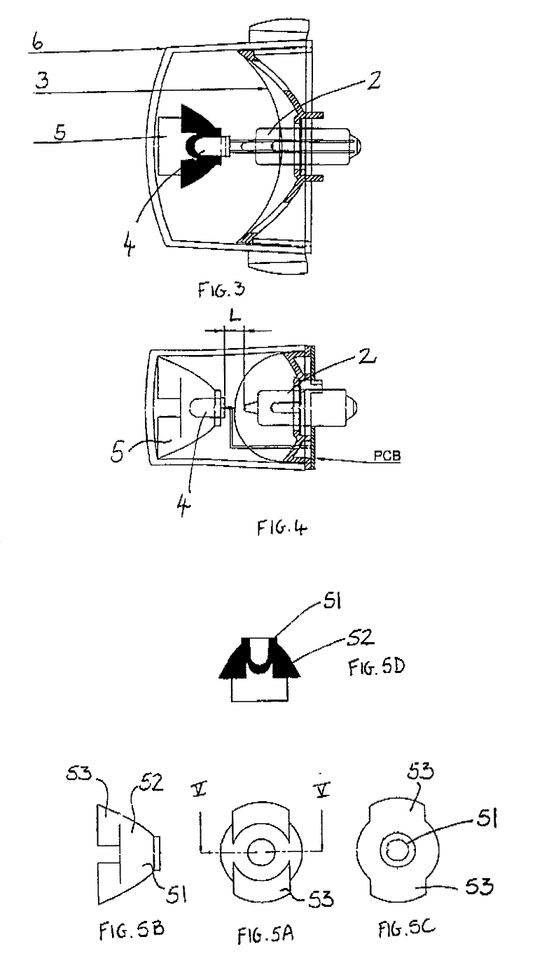

FIGS. 5A to C are respectively a front view, a side view and a rear view of an optical distribution device of the light shown in FIG. 1;

FIG. 5D is a section on line V-V of the optical distribution device shown in FIG. 5A; and

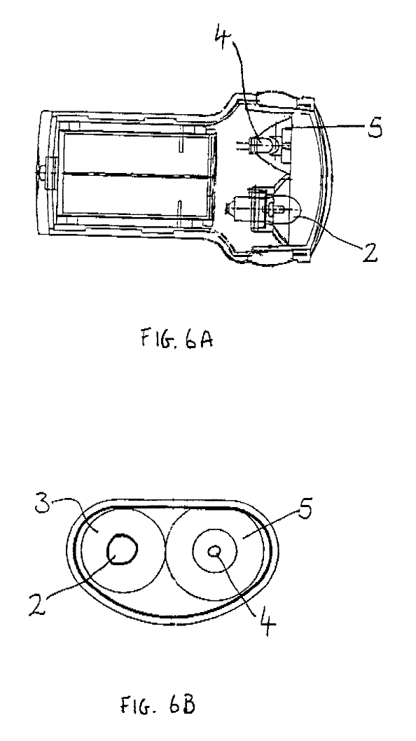

FIGS. 6A and 6B are a schematic plan view and a schematic front view of an alternative bicycle light showing a different arrangement of light sources.

FIGS. 1 and 2 show a bicycle light generally comprising a housing 1 having a battery compartment 1a and a front cover portion 1b. Disposed within the front cover portion 1b are a filament bulb 2 and associated reflector 3 as well as a white LED 4 and associated optical distribution device 5. The front cover portion 1b includes a front surface which acts as a lens 6. The torch also comprises various other components such as a switch and the necessary wiring and electronics to supply electric current to the two light sources 2, 4. However, the details of such elements are not shown or described herein as these may be provided using standard techniques.

Referring particularly to FIGS. 3 and 4, the reflector 3 is parabolic and the filament lamp is disposed at its optical axis. The LED 4 and associated optical distribution device 5 are disposed directly in front of the filament bulb 2 and are thus within a projection area of the reflector 3 and indeed, the optical axis of the optical distribution device 5 is substantially coincident with the optical axis of the reflector 3. The rear of the LED 4 is spaced from the front of the filament bulb 2 by a selected minimum distance L of, say 5 mm, to ensure that the LED does not become overheated when the bulb 2 is in operation.

Beside the fact that the front cover portion 1a of the housing is extended forward to accommodate the LED 4 and optical distribution device 5, the housing 1, reflector 3 and bulb 2 arrangement are substantially the same as they would be in a standard torch in which no LED light source was provided. This arrangement has advantages because it leads to a particularly compact design and enables a large number of common components to be used in traditional filament bulb only lights and dual light source lights of the type to which this application relates. Further, by appropriate design of the optical distribution device 5 and the lens 6, the desired beam characteristics, as specified in international standards for bicycle lights, can be met.

As shown in FIG. 2, the lens 6 is provided with vertical pillow lenses 6a in two regions on either side of the centre of the lens 6. However, both of the extremes 6b of the lens 6 are left free of pillow lenses. In the case of this bicycle light, the bands of pillow lenses have been narrowed to leave a greater area of clear lens 6b at the edges, than would be provided in a light including only a filament bulb 2. Thus in this case, a portion in the order of a quarter to a sixth of the total width of the lens 6 is left free of pillow lenses 6a at each end of the lens 6. This arrangement is used to achieve the desired beam shape and intensity pattern.

The optical distribution device 5 will now be described in more detail with particular reference to FIGS. 5A to 5D. The optical distribution device 5 is made of a single piece of a suitable optical material. Typically this is a colourless plastic. The optical distribution device 5 comprises a LED receiving portion 51 and a light distributing portion 52. Where such optical distribution devices are used in existing LED only lights, the whole optical distribution device is generally frusto-conical. In the present embodiment however, a modified form of optical distribution device 5 is used. Again the overall shape is generally frusto-conical (although it will be noted that the side walls are in fact slightly curved in both directions), but part of the frusto-conical shape is removed to leave two partial frusto-conical light directing projections 53. These projections 53 are spaced from one another in a direction substantially perpendicular to the direction in which the greatest beam width is desired when using the filament bulb 2. It will be appreciated that since the optical distribution device 5 is disposed in front of the filament bulb 2 and the reflector 3, it will tend to obscure or deflect light issued from the filament bulb 2. Removing portions of the optical distribution device 5 so as to leave the two projections 53, helps to limit the obscuring effect in the horizontal direction as shown in FIGS. 5A and 2. At the same time however, because of the provision of the projections 53 and the remainder of the light projecting portion 52, the performance of the optical distribution device 5 when directing light from the LED 4 is not excessively compromised.

Electronic circuitry (not shown) for driving the LED is typically provided such that the LED can be used in a variety of flashing, continuous, and perceived continuous modes. Further, a switch arrangement (not shown) is typically such that operation of the filament bulb and LED can be selected by successively operating the switch.

FIGS. 6A and 6B show an alternative bicycle light in which the filament lamp 2 and associated reflector 3 are provided in a side by side relation to the LED 4 and its associated optical distribution device 5. With such an arrangement, as opposed to the inline arrangement of the device shown in FIGS. 1 to 5, more modification from the design of a standard filament bulb light is needed. In particular, it can become necessary to change the shape of the housing as a whole and to provide a special reflector 3. In this light however, the optical distribution device 5 can be of a more standard design; the cut-out portions and projections 53 as described above in respect of FIGS. 5A to 5D not being required. Although such an arrangement is generally considered less desirable than the inline arrangement, it does have the advantage that the functioning of the optical distribution device 5 as well as the filament bulb 2 and associated reflector 3 can be independently optimised.

1. An electric torch comprising a housing and two light sources, wherein a first of the light sources comprises a filament bulb and a second of the light sources comprises an LED.

2. An electric torch according to claim 1, in which the housing is a common housing in which both of the light sources are housed.

3. An electric torch according to claim 1 comprising a reflector for directing the beam of the filament bulb.

4. An electric torch according to claim 1 comprising an optical distribution device provided for directing light output by the LED.

5. An electric torch according to claim 1 comprising an optical distribution device for directing light output by the LED and a reflector for directing the beam of the filament bulb.

6. An electric torch according to claim 5, in which the axis of the optical distribution device is substantially parallel to the axis of the reflector.

7. An electric torch according to claim 4, wherein a directing portion of the optical distribution device is generally frusto-conical.

8. An electric torch according to claim 4 in which the optical distribution device comprises two spaced light directing projections, which project beyond the remainder of the light directing portion.

9. An electric torch according to claim 8 in which the directing projections are spaced in a direction substantially perpendicular to a direction in which the greatest filament bulb beam width is desired.

10. An electric torch according to claim 1 comprising a lens for directing the light of at least one of the filament bulb and the LED.

11. An electric torch according to claim 10 in which pillow lenses are provided on the lens.

12. An electric torch according to claim 11, in which edge portions of the lens are left free of pillow lenses.

13. An electric torch according to claim 3 in which the LED is disposed within a projection area of the reflector.

14. An electric torch according to claim 1 in which the filament bulb and LED are spaced from one another in a direction generally transverse to the direction of the output beam of at least one of the light sources.

15. An electric torch according to claim 1, in which the filament bulb and LED are spaced from one another in a direction generally parallel to the direction of the output beam of one or both of the light sources.

16. An electric torch according to claim 6, in which the axis of the optical distribution device is substantially coincident with the axis of the reflector.

17. An electric torch comprising a housing and being arranged to receive two light sources, wherein a first of the light sources comprises a filament bulb and a second of the light sources comprises an LED.

18. An electric torch comprising a housing and two light sources, wherein a first of the light sources comprises a filament bulb and a second of the light sources comprises an LED, wherein the filament bulb and LED are disposed in an inline arrangement.
